(19) United States
(12) Patent Application Publication
(10) Pub. No.: US 2017/0212771 A1
(43) Pub. Date: Jul. 27, 2017

(54) DISTRIBUTION AND CUSTOM DISPLAY OF GRAPHICAL COMPONENTS

(71) Applicant: Evasyst, Inc., Irvine, CA (US)

(72) Inventors: Justin Weissberg, Ladera Ranch, CA (US); Jordan Baucke, Highlands Ranch, CO (US)

(21) Appl. No.: 15/052,635

(22) Filed: Feb. 24, 2016

Related U.S. Application Data
(60) Provisional application No. 62/287,823, filed on Jan. 27, 2016.

(51) Int. Cl. G06F 9/44; G06F 3/0484; A63F 13/95; A63F 13/20; A63F 13/25; A63F 13/30; G06F 3/0482; G06F 3/0486

(52) U.S. Cl. CPC G06F 9/4443; G06F 3/0482; G06F 3/04845; G06F 3/0486; A63F 13/20; A63F 13/25; A63F 13/30; A63F 13/95; A63F 2300/206

(57) ABSTRACT

A GUI component can be automatically displayed or customized, such as through location redeployment; color changes, shape changes, transcoding, or other modifications. In some implementations, GUI component customization can include cross-platform GUI component distribution. In some implementations, GUI component customization can be accomplished by providing views of GUI components that are not standard in the GUI applications, to provide input to the GUI applications, and to interact with other users across multiple GUI applications and devices. In some implementations, GUI component customization can include GUI component extraction and redeployment. In some implementations, GUI component customization can include auto-launching GUI components or a control window upon loading a gaming application.

### CROSS-REFERENCE TO RELATED APPLICATIONS

This application claims priority to U.S. Provisional Patent Application No. 62/287,823 entitled “DISTRIBUTION AND CUSTOM DISPLAY OF GRAPHICAL COMPONENTS,” and filed on Jan. 27, 2016, which is hereby incorporated by reference in its entirety.

### BACKGROUND

Computing applications can be divided into three categories: applications that do not provide a user interface, such as background processes in an operating system; applications that provide a text-based interface, such as applications run from a unix command line; and applications that provide a graphical user interface (“GUI”). GUI applications in this third category, while often appearing to be fully integrated, often comprise multiple distinct GUI components that are mapped to different areas on a display, e.g. through absolute or relative positioning.

As used herein, a “GUI component” is any visual element of an application. A GUI component can be a combination of multiple other GUI components, such as an entire display available to a particular user, regardless of whether the user is currently viewing that display. For example, a game GUI application can have multiple views that a user can switch between for controlling different aspects of the game. An individual view that is encapsulated as a video feed, showing multiple GUI sub-components, can be a referred to as a single GUI component. GUI components can be mapped into a gameplay area, such as a 2D or 3D environment, or into a controls area, such as a mini map, settings panel, or other modules that provide game data or access to manipulate other portions of the game.

GUI applications are created for a variety of devices such as PCs, tablets, gaming consoles, mobile phones, etc. In many countries, people interact with multiple such devices on a daily basis. One study found that, in countries such as Germany, the United States, and Australia, the average person owns between three and four devices. For example, people often own a laptop, a smart phone, and a gaming console.

While device manufacturers have developed a variety of applications for sharing content between these devices, such applications are often cumbersome, limited to communications between devices by the same manufacturer, difficult to set up, lacking access to individual GUI components, or unintuitive.

### BRIEF DESCRIPTION OF THE DRAWINGS

FIG. 1 is a block diagram illustrating an overview of devices on which some implementations can operate.

FIG. 2 is a block diagram illustrating an overview of an environment in which some implementations can operate.

FIG. 3 is a block diagram illustrating components which, in some implementations, can be used in a system employing the disclosed technology.

FIG. 4 is a flow diagram illustrating a process used in some implementations for multi-platform content distribution.

FIG. 5A is a flow diagram illustrating a process used in some implementations for redeployment of a GUI component to an alternate location.

FIG. 5B is a flow diagram illustrating a process used in some implementations for client operations in redeployment of a GUI component to an alternate location.

FIG. 5C is a flow diagram illustrating a process used in some implementations for server operations in redeployment of a GUI component to an alternate location on a second client device.

FIG. 6A is a flow diagram illustrating a process used in some implementations for auto-launching display configurations.

FIG. 6B is an example of a display implementing auto-launching of a game lobby and a control window display configuration.

FIG. 6C is an example of a display implementing auto-launching of an in-progress game with a multi-player split-screen display configuration.

The techniques introduced here may be better understood by referring to the following Detailed Description in conjunction with the accompanying drawings.

### DETAILED DESCRIPTION

Embodiments for GUI component customization such as distribution, modification, redeployment, or automatic display are described. In some implementations, GUI component customization can be accomplished using a customization system, where the customization system can interact with various GUI applications to: provide views of GUI components which are not standard in the GUI applications, provide input to the GUI applications, and interact with other users across multiple GUI applications and devices. In some implementations, GUI component customization can include cross-platform GUI component distribution. In some implementations, GUI component customization can include GUI component extraction and redeployment. In some implementations, GUI component customization can include auto-launching GUI components or a control window upon loading a gaming application.

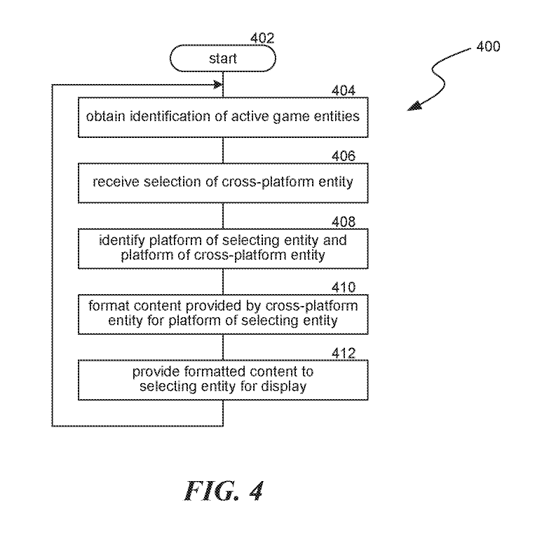

The customization system can perform cross-platform GUI component distribution by obtaining GUI components from a first type of device (e.g. game console, PC, mobile phone, etc.) or a device using a particular operating system (e.g. Windows™′ iOS™, Android™, etc.) and providing the obtained GUI components to another device type or device using a different operating system type. As used herein, “cross-platform” refers to communications, either directly or through a server, between different types of devices, devices implementing different operating systems, devices that use different encoding, or other devices that require modification of GUI components created on a first system to be displayed on the cross-platform system. For example, a user of a PC that wants to watch a game being played on a gaming console can use a first version of the customization system executing on the user's PC to select the game, where the game console is also executing a second version of the customization system. In response to the selection, the second version of the customization system can obtain a GUI component comprising a video feed that corresponds to the gameplay area on the game console and transmit the video feed to a server. The server can adjust the video feed for display on the PC through the first version of the customization system such as by transcoding it, adjusting frame rates, adjusting resolution, etc. The adjusted video feed can then be sent to the PC and displayed so that the user of the PC can watch the game. Additional details regarding cross-platform GUI component distribution are provided below, such as in relation to FIG. 4.

The customization system can perform GUI component extraction and redeployment by receiving a selection of a GUI component along with an instruction for customization, such as a redeployment location or device for the GUI component, or an indication of a modification to the GUI component, such as for its size or the colors it uses. The customization system can obtain GUI components of an application using, e.g., a Software Development Kit (“SDK”) provided by the GUI application, a plug-in or other extension added to a GUI application, or by capturing a portion of display output of a GUI application, such as in a video feed or image capture. A user can select a GUI component for redeployment, e.g., from a list of GUI components that can be redeployed, using a tool provided with GUI components, or using a GUI component selection procedure. For example, the customization system can include a window that encapsulates the output of a game; and part of this encapsulation can include providing additional controls. One of these controls can include a GUI component redeployment control. When this control is selected, a user may be able to select one or more currently displayed GUI components for redeployment. For example, when the redeployment control is selected, GUI components that are currently displayed that can be accessed through an SDK of the game can be highlighted in a first color and those selected by a user can be highlighted in a second color.

Once selected, the customization system can provide additional tools for redeployment or modification of the selected GUI components. Modification of the selected GUI components can include changing colors, sizes, shapes, or applying a predefined “skin” to a GUI component. The customization system can store a mapping of modifications to the selected GUI components, so that the customization system can automatically apply the same modifications to the GUI components when the application is executed again. Redeployment can include moving a GUI component to a different location within the originating application, moving the GUI component to another window, such as on another monitor, on the device that is executing the originating application, or moving the GUI component to a location on another device. Continuing the above example, once the user has selected one or more GUI components, the user can select a “move” tool which will enable the user to drag the selected GUI components to another location in the same window or a different window on the user's device. Alternatively, the user may have identified one or more other devices to the customization system, and when the user selects the move tool a representation of these devices can appear. The user can then indicate redeployment of GUI components by dragging them to one of these device representations. In a second version of the customization system executing on the device the user indicated that the GUI component should be redeployed to, an indication can be provided to the user of the redeployment, and the user can be further enabled to position the received GUI components on the second device. The customization system at one or more of: the version executing on the first device, a server, or the second device, can store a mapping of the GUI components to a location where they have been redeployed. This mapping can be used by the customization system to automatically redeploy the GUI components when the GUI application is executed again.

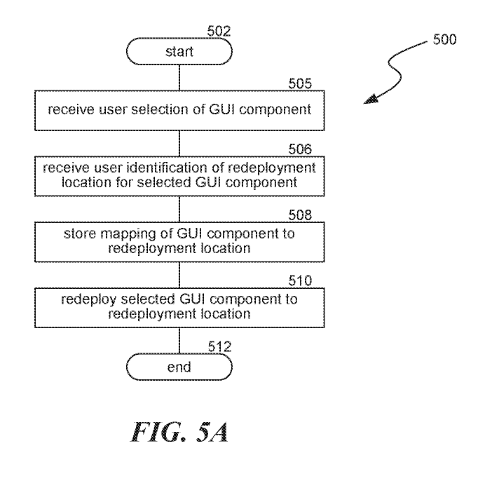

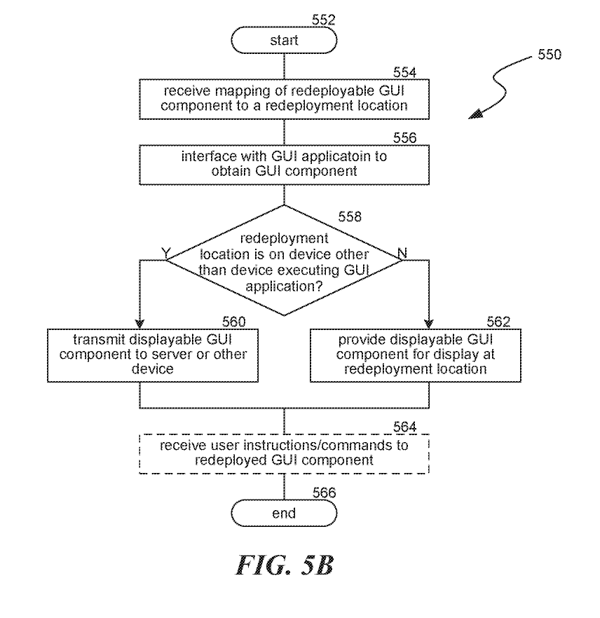

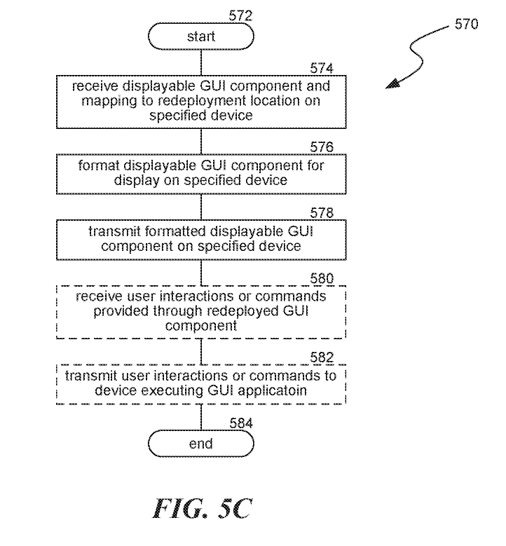

In some implementations, once a GUI component has been redeployed, a user can interact with the GUI component to provide input to the originating application, even if that originating application is executing on another device. For example, a game executing on a game console can have a secondary screen used to control a vehicle in the game; however that secondary screen may obscure part or all of the main screen of the game when in use, thus making the user's character in the main screen vulnerable. Using the customization system executing on the game console, the user can redeploy the secondary screen to a second version of the customization system executing on their laptop. The user may then be able to view both the main screen, through viewing the output of the game console, and the secondary screen, through the user's laptop, at the same time. In addition, the user can continue to provide commands to control the character in the main screen using the game console controller while at the same time providing commands to control the vehicle through the laptop. The version of the customization system executing on the laptop can route the commands back to the customization system executing on the game console, which can provide them as input to the game, thereby controlling the vehicle. For example, if the vehicle is a bomber plane on a particular course, when the user wants the plane to drop its bomb, he can issue a spoken command “bombs away” to the laptop, which will route the command to the virtual plane in the game; all the while the user can continue to move and interact with his character in the main screen. Additional details regarding GUI component extraction and redeployment are provided below, such as in relation to FIGS. 5A-C.

In some implementations, GUI component customization can include, upon loading an in-progress game application, auto-launching GUI components comprising video feeds of multiple users of the game application. For example, the customization system can include a “friends list” that shows representations of other users or gaming devices that a user has previously identified or interacted with. This list can include a control allowing the user to select an in-progress game the user would like to watch. Upon selecting the in-progress game, the customization system can provide a first GUI component comprising a video feed of the game play of the selected user or gaming device. This first GUI component can be displayed in a window on a first monitor of the selecting user's system. In addition, the customization system can provide additional GUI components comprising video feeds of the game play from other players in the game; such as four-way split screen of four team members corresponding to the selected user or gaming device. These additional GUI components can be displayed in a window on a second monitor of the selecting user's system. In this way, a user can immediately jump into the action, viewing the display of multiple users in game they would like to view.

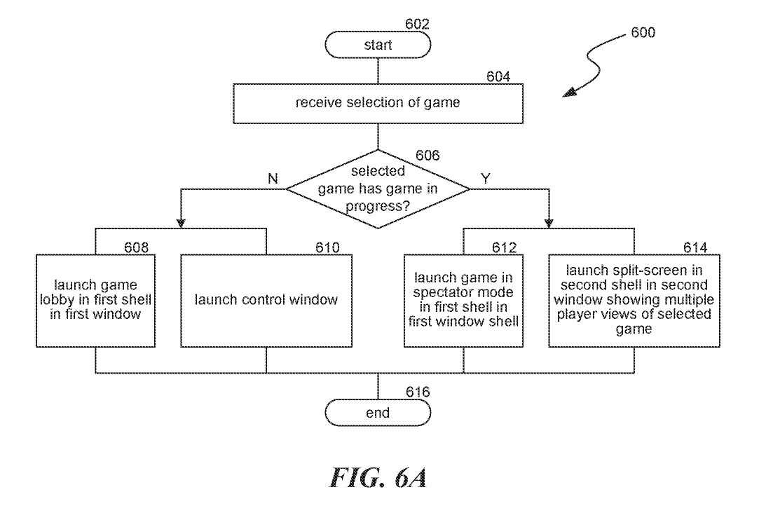

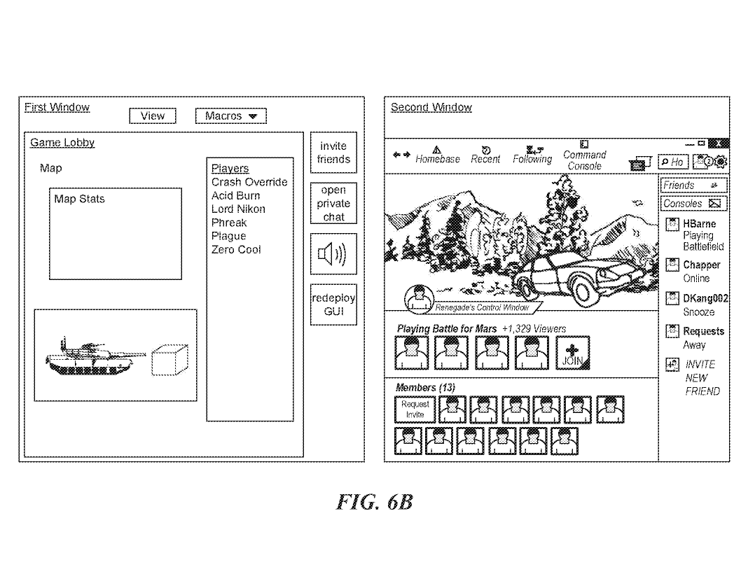

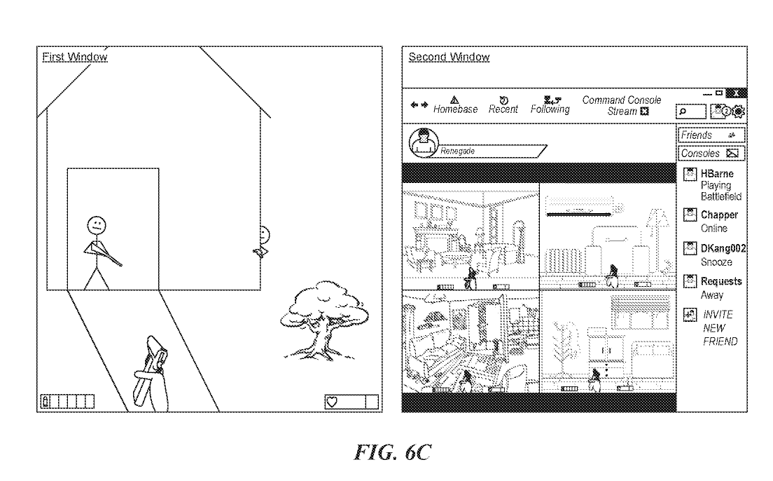

In some implementations where the game is not yet in-progress, GUI component customization can include, upon loading a game application, auto-launching GUI components showing a lobby view of the game application while also launching a control window. For example, a user can execute a game on a daily device such as their PC. The customization system can automatically load a lobby for the game in a first window of the PC, for example on a first monitor. Additionally, the customization system can automatically load a control window of the customization system, for example on a second monitor. The control window can provide the user the ability to interact with other users or applications associated with the customization system, such as in chat areas; asynchronous messaging systems; user ranking, statistics or leader boards; an e-commerce interface for in-game purchases; or etc. Additionally or alternatively, the control window can provide controls for the game, such as shortcuts to commands, established macros, messaging interfaces to other game players, GUI component redeployment or modification tools, etc. Additional details regarding GUI component auto-launching upon an application selection are provided below, such as in relation to FIGS. 6A-C.

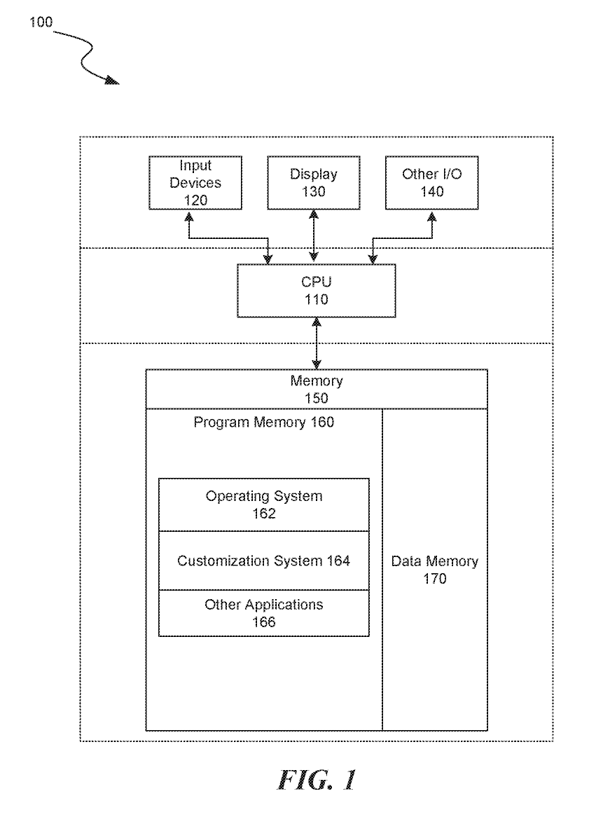

Several implementations are discussed below in more detail in reference to the figures. Turning now to the figures, FIG. 1 is a block diagram illustrating an overview of devices on which some implementations of the disclosed technology can operate. The devices can comprise hardware components of a device 100 that can manipulate the graphical content provided by various applications on various systems. Device 100 can include one or more input devices 120 that provide input to the CPU (processor) 110, notifying it of actions. The actions are typically mediated by a hardware controller that interprets the signals received from the input device and communicates the information to the CPU 110 using a communication protocol. Input devices 120 include, for example, a mouse, a keyboard, a touchscreen, an infrared sensor, a touchpad, a wearable input device, a camera- or image-based input device, a microphone, or other user input devices.

CPU 110 can be a single processing unit or multiple processing units in a device or distributed across multiple devices. CPU 110 can be coupled to other hardware devices, for example, with the use of a bus, such as a PCI bus or SCSI bus. The CPU 110 can communicate with a hardware controller for devices, such as for a display 130. Display 130 can be used to display text and graphics. In some examples, display 130 provides graphical and textual visual feedback to a user. In some implementations, display 130 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 140 can also be coupled to the processor, such as a network card, video card, audio card, USB, firewire or other external device, camera, printer, speakers, CD-ROM drive, DVD drive, disk drive, or Blu-Ray device.

In some implementations, the device 100 also includes a communication device capable of communicating wirelessly or wire-based with a network node. The communication device can communicate with another device or a server through a network using, for example, TCP/IP protocols. Device 100 can utilize the communication device to distribute operations across multiple network devices.

The CPU 110 can have access to a memory 150. A memory includes one or more of various hardware devices for volatile and non-volatile storage, and can include both read-only and writable memory. For example, a memory can comprise random access memory (RAM), CPU registers, read-only memory (ROM), and writable non-volatile memory, such as flash memory, hard drives, floppy disks, CDs, DVDs, magnetic storage devices, tape drives, device buffers, and so forth. A memory is not a propagating signal divorced from underlying hardware; a memory is thus non-transitory. Memory 150 can include program memory 160 that stores programs and software, such as an operating system 162, content manipulation system 164, and other application programs 166. Memory 150 can also include data memory 170 that can include GUI components, component redeployment or modification mappings, listings of user login activity, identifications devices associated with particular users, GUI component skins, transcoding algorithms or modules, GUI applications, plug-ins for GUI applications, addresses or other connection data for additional versions of the customization system, configuration data, settings, user options or preferences, etc., which can be provided to the program memory 160 or any element of the device 100.

Some implementations can be operational with numerous other general purpose or special purpose computing system environments or configurations. Examples of well-known computing systems, environments, and/or configurations that may be suitable for use with the technology include, but are not limited to, personal computers, server computers, handheld or laptop devices, gaming consoles, cellular telephones, wearable electronics, tablet devices, multiprocessor systems, microprocessor-based systems, set-top boxes, programmable consumer electronics, network PCs, minicomputers, mainframe computers, distributed computing environments that include any of the above systems or devices, or the like.

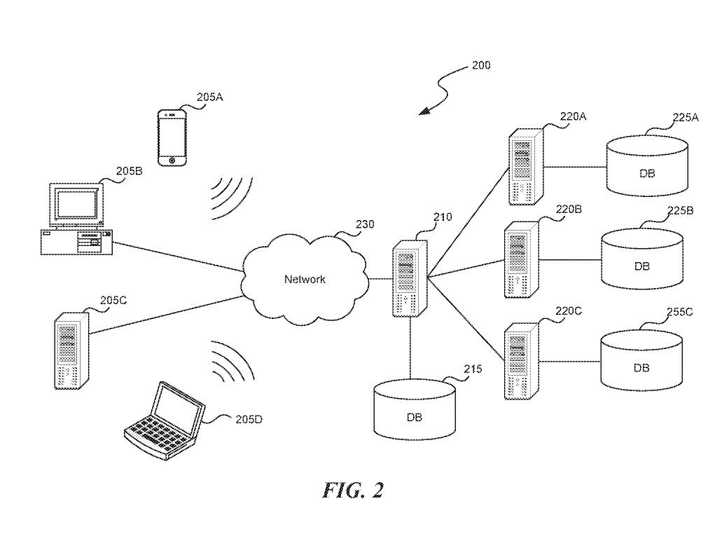

FIG. 2 is a block diagram illustrating an overview of an environment 200 in which some implementations of the disclosed technology can operate. Environment 200 can include one or more client computing devices 205A-D, examples of which can include device 100. Client computing devices 205 can operate in a networked environment using logical connections 210 through network 230 to one or more remote computers, such as a server computing device.

In some implementations, server 210 can be an edge server which receives client requests and coordinates fulfillment of those requests through other servers, such as servers 220A-C. Server computing devices 210 and 220 can comprise computing systems, such as device 100. Though each server computing device 210 and 220 is displayed logically as a single server, server computing devices can each be a distributed computing environment encompassing multiple computing devices located at the same or at geographically disparate physical locations. In some implementations, each server 220 corresponds to a group of servers.

Client computing devices 205 and server computing devices 210 and 220 can each act as a server or client to other server/client devices. Server 210 can connect to a database 215. Servers 220A-C can each connect to a corresponding database 225A-C. As discussed above, each server 220 can correspond to a group of servers, and each of these servers can share a database or can have their own database. Databases 215 and 225 can warehouse (e.g. store) information such as component redeployment or modification mappings, user settings, listings of user login activity, identifications of devices associated with particular users, etc. Though databases 215 and 225 are displayed logically as single units, databases 215 and 225 can each be a distributed computing environment encompassing multiple computing devices, can be located within their corresponding server, or can be located at the same or at geographically disparate physical locations.

Network 230 can be a local area network (LAN) or a wide area network (WAN), but can also be other wired or wireless networks. Network 230 may be the Internet or some other public or private network. Client computing devices 205 can be connected to network 230 through a network interface, such as by wired or wireless communication. While the connections between server 210 and servers 220 are shown as separate connections, these connections can be any kind of local, wide area, wired, or wireless network, including network 230 or a separate public or private network.

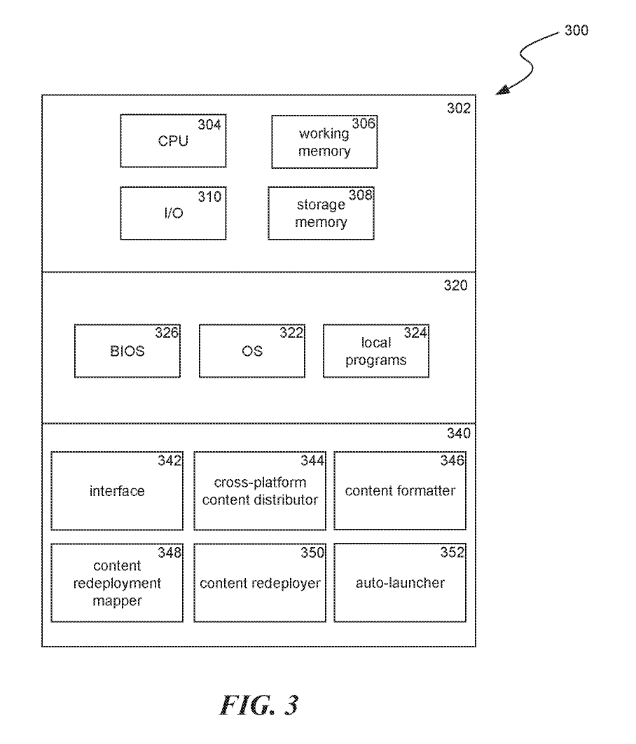

FIG. 3 is a block diagram illustrating components 300 which, in some implementations, can be used in a system employing the disclosed technology. The components 300 include hardware 302, general software 320, and specialized components 340. As discussed above, a system implementing the disclosed technology can use various hardware including central processing units 304, working memory 306, storage memory 308, and input and output devices 310. Components 300 can be implemented in a client computing device such as client computing devices 205 or on a server computing device, such as server computing device 210 or 220.

General software 320 can include various applications including an operating system 322, local programs 324, and a basic input output system (BIOS) 326. Specialized components 340 can be subcomponents of a general software application 320, such as local programs 324. Specialized components 340 can include: cross-platform content distributor 344, content formatter 346, content redeployment mapper 348, content redeployer 350, auto-launcher 352, and components which can be used for transferring data and controlling the specialized components, such as interface 342. In some implementations, components 300 can be in a computing system that is distributed across multiple computing devices or can include an interface to a server-based application.

Cross-platform content distributor 344 can be configured to receive identifications of GUI components, such as a video feed of a game, from a first device type or device with a first operating system type, and provide the GUI components to a second device type different from the first device type or to a device with a second operating system type different from the first operating system type (e.g. a “cross-platform” entity). Providing the identified GUI components to the second device type or to the device with a second operating system can be accomplished using content formatter 346, described below, to convert the GUI components into a format compatible with the second device type or second operating system.

In some implementations, the identification of the GUI component for cross-platform distribution is performed by providing, to a user, identifications of active game entities, allowing the user to select one of the active game entities, and receiving GUI components, where the GUI components are automatically selected corresponding to activities of the selected active game entity. As used herein, a “game entity” can be any user of a gaming system or a device that can access the gaming system, such as a game console, phone, tablet, PC, wearable device, etc. As used herein, a game entity is “active” when the game entity can interact with a portion of a game or other game entities of the gaming system, e.g. when the game entity is logged into the gaming system or is in a game that is linked to the gaming system (e.g. is playing a game or is the game lobby known to the gaming system). In some implementations where the active game entity is in a game lobby waiting for a game to start, the automatically selected GUI components corresponding to the active game entity can be a representation of the game lobby the game entity is in. In some implementations where the active game entity is currently playing a game, the automatically selected GUI components corresponding to the active game entity can be a representation of a gameplay area for the game the active game entity is participating in. In some implementations, the selected GUI components can also include representations of the gameplay area for other players of this game, such as for teammates of the active game entity, selected other game players, highest ranked players, or players that are leading in the game. In some implementations, the automatically selected GUI components corresponding to the active game entity can be a representation of a messaging area (e.g. chat room, IM interface, etc.) which can be used to contact the active game entity.

Content formatter 346 can be configured to receive a GUI component and an identification of a recipient system and format the GUI component for display on the recipient system. In various implementations, formatting the GUI component can comprise: transcoding the GUI component (e.g. for use with a different codec), adjusting a size of the GUI component, adjusting a resolution of the GUI component, adjusting a frame rate of the GUI component, etc. In some implementations, content formatter 346 can perform the modifications of a GUI component based on features identified for the recipient system, such as a type of device of the recipient system, the operating system of the recipient system, a display size or type of the recipient system, software available on the recipient system such as decoders, hardware available on the recipient system such as capabilities of a video card, or other GUI components which the received GUI component will be integrated with. For example, the recipient system may be currently displaying four video feeds each showing a gameplay area from the perspective of different players of a game. Content formatter 346 can format the GUI components, adjusting the size and resolution of each GUI component corresponding to capabilities of the recipient system, so the recipient system can concurrently display each of the four video feeds.

Content redeployment mapper 348 can be configured to receive user selections of one or more GUI components and a redeployment location (or locations) for the selected GUI components, store a mapping of the GUI components to the redeployment location(s), and use content redeployer 350 to move or duplicate the GUI components identified in the mapping to the redeployment location(s). In various implementations, users can provide GUI component selections to the content redeployment mapper 348 by selecting GUI components from a GUI component manager (e.g. a list, checkboxes, search field, etc.) or by indicating one or more GUI components currently displayed to the user. Which GUI components can be selected for redeployment mapper 348 can be dictated by which GUI components are accessible by an SDK of a GUI application or a plug-in to a GUI application.

In various implementations, users can provide a redeployment location for GUI components to the content redeployment mapper 348 by selecting an available redeployment location from a listing, dragging GUI components to a location or otherwise indicating a redeployment location by interacting with that location, or providing coordinates of a redeployment location. In some implementations, the user can select a redeployment location on a device other than the device executing the GUI application, for example by selecting the alternate device from a list or providing an identifier corresponding to the alternate device. Either with the identification of the alternate device or subsequent to that identification, a location on the alternate device can also be selected, such as at particular coordinates in a window of a customization system executing on the alternate device. In some implementations, the redeployment location, whether on the device executing the GUI application or on another device, can be a default location. For example, if the selected GUI components are views of the gameplay of four teammates for a game GUI application, the views can be automatically sized to fit within the window of the customization system, such as in a four-way split-screen type view. When the redeployment location is on a device other than the device executing the GUI application, redeployment of the GUI components can comprise providing the GUI components to a version of content formatter 346 that can format the GUI components for display on the destination device.

In some implementations, content redeployment mapper 348 can be part of a server system used to receive user indications of user redeployment mappings. The server version of the content redeployment mapper 348 can use the mappings to direct GUI components received from an executing GUI application to an alternate device indicated for redeployment of the GUI component in the mapping. The server version of the content redeployment mapper 348 can also store the redeployment mappings for later re-implementations of GUI component redeployments.

Content redeployer 350 can be configured to receive a mapping of GUI components to redeployment locations, e.g. from content redeployment mapper 348, and can move or copy the GUI components identified in the mapping to the identified redeployment locations. In some implementations, content redeployer 350 can access the identified GUI components using an SDK or a plugin for the GUI application that includes the GUI components. For example, the mapping can have a GUI application name and GUI component ID (e.g. elementID). Content redeployer 350 can use an SDK associated with the GUI application to initiate an GUI control programming object (e.g. GUIController) and call a method of that programming object (e.g. GUIController.getGUIElement(elementID)) to obtain a reference to the GUI component or a reference to the GUI component. In some implementations, content redeployer 350 can be implemented on a second device, executing a version of the customization system, where the redeployment location identifies the second device. In this case, content redeployer 350 can receive the GUI component from another device, such as the device executing the GUI application, which, in some cases, can be passed through a server.

In some implementations, content redeployer 350 can redeploy GUI components locally from the GUI application to another location within the GUI application, to another location within a window encompassing the GUI application, or to another widow distinct from the GUI application. In some implementations, local GUI component redeployment can comprise accessing a window associated with the redeployment location in the received mapping and performing a procedure to place the obtained GUI component at a specified location within that window. For example, the redeployment location can include a window identification such as “secondary_monitor_window” and a set of coordinates such as 400,220. Content redeployer 350 can access a programming object associated with the identified window (e.g. secondaryMonitorWindow), and can place a received GUI component (e.g. GUIComponent) using a GUI component placement function of the window programming object (e.g. secondaryMonitorWindow.displayGUIComponentAt(GUIComponent, (400,220))).

In some implementations, a version of content redeployer 350 can be implemented on a server. The server version of content redeployer 350 can receive a GUI component and a mapping to a redeployment location on a specified device. Content redeployer 350 can use content formatter 346 to format the received GUI component for the device identified in the mapping (e.g. size, encoding, framerate, etc., as discussed above). The server version of content redeployer 350 can then transmit the formatted GUI component to the destination device identified in the mapping.

In some implementations where the destination device is different from the device executing the GUI application, the GUI component displayed on the destination device can be interactive. When a user of the destination device interacts with the GUI component, the interactions can be transmitted back to the GUI application, either directly or through a server. A version of the customization system local to the device executing the GUI application can receive the interactions and provide the interactions to the GUI application, such as by using a plugin or SDK of the GUI application or by mimicking user input, e.g. by providing virtual mouse/keyboard inputs.

Auto-launcher 352 can be configured to receive a selection of a game GUI application, either through a game manager or through a customization system. In some implementations, the selection of a game GUI application can be a selection of a user or game device that is playing a game or waiting for a game to begin. If the selected game GUI application has an in-progress game, auto-launcher 352 can both: A) launch the game in a spectator mode within a first window of the customization system and B) launch a split screen view in a second window of the customization system showing multiple player views of the selected game GUI application. If the selected game GUI application does not have an in-progress game, auto-launcher 352 can both: A) launch a view of a lobby of the game within a first window of the customization system and B) launch a control window of the customization system. In some implementations, the control window can provide the user the ability to interact with other users or applications associated with the customization system, such as in chat areas; asynchronous messaging systems; user ranking, statistics or leader boards; an e-commerce interface for in-game purchases; etc. Additionally or alternatively, the control window can provide controls for the game, such as shortcuts to commands, established macros, messaging interfaces to other game players, GUI component redeployment or modification tools, etc.

Those skilled in the art will appreciate that the components illustrated in FIGS. 1-3 described above, and in each of the flow diagrams discussed below, may be altered in a variety of ways. For example, the order of the logic may be rearranged, substeps may be performed in parallel, illustrated logic may be omitted, other logic may be included, etc. In some implementations, one or more of the components described above can execute one or more of the processes described below.

FIG. 4 is a flow diagram illustrating a process 400 used in some implementations for multi-platform content distribution. Process 400 begins at block 402 and continues to block 404. At block 404, process 400 can obtain identifications of active game entities. As discussed above, a game entity can be a user of a game or gaming system, either through accessing a game or a customization system, or can be a gaming device (e.g. a PC, console, phone, tablet, headset, watch, PC, etc.) that executes a game application or that accesses a server executing the game application. The game entity is active when the game entity can interact with a portion of the game, e.g. when the user is considered online with the game, when the user is running the game, when the gaming device is executing the game, or when the gaming device is connected to a server executing the game. In some implementations, process 400 can be performed by a server-based application that allows game entities to interact, view each other's games, or provide additional controls to games.

At block 406, process 400 can receive a selection, by a selecting entity such as a user of the gaming system, of a cross-platform entity. As discussed above, a cross-platform entity is a game entity that is operating on a different type of device than a selecting game entity, a device with a different operating system than a selecting game entity, or on a device different from that of a selecting game entity that requires a modification of GUI components for the GUI components to be displayed. In some implementations, a user of a gaming system can select a cross-platform entity by selecting a gaming entity through the gaming system, e.g. from a list of previously identified “friend,” “following,” or “recently viewed” gaming entities, from a list of active gaming entities (e.g. organized by rating, online time, game being played or mostly commonly played, play style, common friends, etc.), or from a search portion of the gaming system (e.g. that can search for user names or other user attributes, games or game types, system types, etc.).

At block 408, process 400 can identify the platform or other characteristics of the selected cross-platform entity or the selecting entity. Such characteristics can include a device type, operating system, encoding scheme, display capabilities, communication speeds or capabilities, available software, etc. In various implementations, the characteristic identification can be performed by querying the device of the cross-platform entity or the device of the selecting entity, by receiving self-reporting characteristics e.g. from a registration process of the cross-platform entity or the selecting entity, by checking stored previous identifications of characteristics of the cross-platform entity or the selecting entity, or by analyzing content provided by the cross-platform entity.

At block 410, process 400 can receive content provided by the cross-platform entity. In some implementations, the received content can be a video feed of an in-progress game. In some implementations, the received content can be a view of a lobby of a game. In some implementations, the received content can be content from a GUI application other than a game. At block 410, process 400 can also format the received content based on the identified the characteristics of the cross-platform entity or the selecting entity. Formatting the content can comprise: transcoding the content (e.g. for use with a different codec), adjusting a size of the content, adjusting a resolution of the content, adjusting a frame rate of the content, etc. Modifications of the content based on features identified for the selecting entity, such as a type of device the selecting entity, the operating system of the selecting entity, a display size or type of the selecting entity, software available on the selecting entity such as decoders, hardware available on the selecting entity such as capabilities of a video card, or other GUI components with which the received content will be integrated. For example, the selecting entity can have selected three games to view currently. Process 400 can, at the server, combine the three video feeds corresponding to the three games into a single video feed displayable on the device of the selecting entity.

At block 412, process 400 can provide the formatted content to the selecting entity. Process 400 can continue to block 404, allowing the selecting entity to identify additional content to view. As a selecting entity identifies additional content (whether or not it's from a cross-platform entity) and process 400 provides the content to the selecting entity, the content can be accumulated by the device of the selecting entity to display this content simultaneously, such as in a split-screen view. The sizes and configurations of these pieces of content can be automatically resized and positioned, such as based on the number of content items selected. For example, when a user selects a first view of a game being played by a second user, the game can be displayed in a first window (e.g. on a first monitor) of the selecting user. When the user selects a second view to watch another player in the same game, the game play of this third user can be displayed in a second window (e.g. on a second monitor) of the selecting user. When the user selects a third view to watch another player of a second game, the game play of this fourth user can be displayed as a split screen of the second window (e.g. on the second monitor) of the selecting user. The selecting user can continue this process, adding as many additional views as they would like. The selecting user can also remove views, which can result in the system automatically removing them and resizing and reorganizing the remaining views. In some implementations, the selecting user can configure how the views are displayed, such as switching which individual view is displayed larger in the first window.

FIG. 5A is a flow diagram illustrating a process 500 used in some implementations for redeployment of a GUI component to an alternate location. In some implementations, process 500 can be performed locally on a system executing a GUI application. Process 500 begins at block 502 and continues to block 504. At block 504, process 500 can receive a user selection of one or more GUI components. The selection can be of any GUI component of a GUI application that process 500 can access, e.g. through a call to an SDK or plugin of the GUI application. In various implementations, the selection can be through a list or selection manager of selectable GUI components, the selection can be by receiving an indication on or to a displayed GUI component, or through a tool associated with one or more GUI components.

At block 506, process 500 can receive an indication of a redeployment location for the GUI component(s). The redeployment location can be within the same window as the GUI application, within a different window on the same device that is executing the GUI application, or a location on a device other than the device that is executing the GUI application. In some implementations, the redeployment location can be a physical location in the world for display of the GUI component, and the GUI component can be viewed as if it were at that location when that physical location is viewed with or through another device. In various implementations, the user can select the redeployment location from a list of available locations or by interacting with a location, such as through a drag-and-drop procedure with the GUI component, an actuation of an indicator (e.g. mouse click) at a selected location, a selection of a device from a displayed set of one or more devices, or by otherwise referencing a location (e.g. by a camera observing a user pointing at a location or a user typing coordinates). In some implementations, the user can also indicate a modification to the GUI component, such as changing colors, sizes, shapes, images, or complete reskinning of the GUI components. For example, the user can indicate that a set of GUI elements should be maintained at their original position but displayed with the colors of her gaming clan.

At block 508, process 500 can store a mapping of the GUI components to the redeployment locations or to other modifications indicated by the user. In various implementations, this mapping can be stored locally on a user's system or can be stored in a database of the customization system. This stored version of the mapping can be used in future executions of the GUI application to make the same modifications or redeployments without requiring the user to reselect the GUI components, redeployment locations, or other modifications.

At block 510, process 500 can redeploy the selected GUI components to the redeployment locations or make the other indicated modifications. This redeployment can comprise obtaining the GUI component, such as through an SDK or plugin for the GUI application and accessing and positioning the GUI component at the redeployment location such as in a local window or through a transmission to another device where the transmission causes the placing the GUI component within a window of that other device. Redeployment of GUI components according to a mapping is discussed in greater detail below in relation to FIGS. 5B and 5C. Process 500 then continues to block 512, where it ends.

FIG. 5B is a flow diagram illustrating a process 550 used in some implementations for client operations in redeployment of a game component to an alternate location. In some implementations, process 550 can be performed locally on a system executing a GUI application. Process 550 begins at block 552 and continues to block 554. At block 554, process 550 can receive a mapping of a GUI component to a redeployment location. In some implementations, this can be a mapping created in process 500.

At block 556, process 550 can interface with a GUI application, such as a game, to obtain the GUI component identified in the mapping. This can comprise making a call to a function of an SDK or plugin for the GUI application.

At block 558, process 550 can determine whether the redeployment location is on a device other than the system executing the GUI application. If so, process 550 can continue to block 560. If not, process 550 can continue to block 562. In some implementations, redeployments are only performed locally, in which case no check for whether the redeployment location is local is necessary. In some implementations, redeployments are performed by always sending GUI components though a server or over a network, in which case no check for whether the redeployment location is local is necessary.

At block 560, process 550 can transmit the GUI component obtained at block 556 to a server or to another device over a network. In some implementations, the destination of this transmission can be based on a device identified in the mapping received at block 554. In some implementations, the other device can be on a local network, such as a WiFi network, and the transmission can be directly to that other device, e.g. over a WiFi router. In some implementations, the transmission can be to a set destination, such as a server established to distribute GUI components to other devices. In some implementations, this transmission can include the mapping received at block 554. Additional details about a server application performing part of a GUI component redeployment procedure are provided below in relation to FIG. 5C.

At block 562, process 550 can provide the GUI component obtained at block 556 for display at the redeployment location. This can be by determining a window associated with the output location, accessing that window, and causing the GUI component to be displayed in that window, e.g. at particular coordinates, at a location relative to edges of the window or relative to other GUI components displayed in that window. In some implementations, the output location can be in a window other than a window containing normal output of the GUI application. For example, where the GUI application is a multi-player game displayed in a window on a first monitor of the device executing the game, a GUI component corresponding to a chat portion of the game can be mapped to a window on a second monitor of the device executing the game.

At block 564, process 550 can receive user interactions or commands provided through the redeployed GUI components. These interactions or commands can be provided back to the GUI application, e.g. through calls to SDK functions or plugin functions associated with the GUI application or by simulating user device input to the GUI application. In some implementations, redeployed GUI components may be for display only, in which case block 564 may not be performed. Process 550 can then continue to block 566, where it ends.

FIG. 5C is a flow diagram illustrating a process 570 used in some implementations for server operations in redeployment of a game component to an alternate location on a second client device. In some implementations, process 500 can be performed locally on a server system. Process 570 begins at block 572 and continues to block 574. At block 574, process 570 can receive a GUI component and a mapping for the GUI component to a redeployment location on a specified output device.

At block 576, process 570 can format the received GUI component for display on the output device. This formatting can be performed in a manner similar to the formatting discussed above in relation to block 410. Formatting the received GUI component can comprise: transcoding the received GUI component (e.g. for use with a different codec), adjusting a size of the received GUI component, adjusting a resolution of the received GUI component, adjusting a frame rate of the received GUI component, etc. Modifications of the received GUI component can be based on features identified for the output device, such as a type of device the output device, the operating system of the output device, a display size or type of the output device, software available on the output device such as decoders, hardware available on the output device such as capabilities of a video card, or other GUI components which the received content will be integrated with. At block 578, process 570 can transmit the formatted GUI component to the output device identified in the mapping received at block 574. This transmission can cause the output device identified in the mapping to display the GUI component at the location identified in the mapping, which can be performed in the same manner as described in relation to block 562.

At block 580, process 570 can receive an indication of a user interaction or command that was given by a user through the GUI component displayed on the output device identified in the mapping. This interaction or command can be a captured input such as pressed buttons, movement, sound, etc. This interaction or command can correspond to particular portions of the GUI component. For example, the interaction can be provided with coordinates relative to the GUI component or can be specific to aspects of the GUI component, such as an indication of an actuation of a button of the GUI component. At block 582, process 570 can transmit the interaction or command to the device executing the GUI application. The interaction or command can be received, e.g. at block 564 of process 550. In some implementations, redeployed GUI components may be for display only, in which case blocks 580 and 582 may not be performed. Process 570 can then continue to block 584, where it ends.

FIG. 6A is a flow diagram illustrating a process 600 used in some implementations for auto-launching display configurations. Process 600 begins at block 602 and continues to block 604. At block 604, process 600 can receive a selection of a game application. In some implementations, a user can make this selection though a game manager configured to provide access to one or more game applications. In some implementations, a user can make this selection by directly executing a game application. In some implementations, a user can make this selection through the customization system configured to provide a community for multiple game applications.

Process 600 can then continue to block 606 where it determines whether or not the selected game application has a game in progress. If so, process 600 continues to blocks 612 and 614. If not, process 600 continues to blocks 608 and 610.

At blocks 608 and 610, process 600 can automatically display two windows corresponding to the selected game application. At block 608, process 600 can show a first window displaying a lobby for the selected game application. In some implementations, this first window can be a shell that encapsulates the normal display of the game application. The lobby can be a waiting area for users to gather until the game starts. In various implementations, when the game starts from the lobby, the user that selected the game application can be included as a player in the game or can be a spectator of other game players. The shell window around the lobby can provide additional controls for the game application, such as audio controls, controls to interact with the game applications such as sending one or more pre-defined actions into the game (e.g. macros), GUI redeployment controls, etc. The shell window can also include controls to interact with other users, such as the ability to invite other users of a customization system to join or view the game, statistics or other information on other users in the lobby, controls to switch to views of other games, etc.

Contemporaneously with the actions of block 608, at block 610, process 600 can show a second window, different from the first window, that displays controls for the customization system. These controls can include various areas such as a friends or a consoles list configured to list other users or game devices associated with the customization system, streams of other games a user is watching, a list of other users identified as of interest or which a user recently viewed, details of one or more particular users, lists of in-progress games, controls for communications between users, an area for making in-game purchases, etc. An example of a display implementing auto-launching a game lobby and a control window display configuration is provided in FIG. 6B. In some implementations, when the game begins, the lobby and control window views can be automatically replaced with the views described below in relation to blocks 612 and 614.

At blocks 612 and 614, process 600 can automatically display two windows corresponding to the selected game application. At block 612, process 600 can show a first window following a first user of the selected game application. In some implementations, the game application can be selected by a user selecting a particular user playing a game, such as by selecting a friend, a user previously identified, or by responding to an invitation to view a game. In some implementations, the selecting user can be a player in the game, and the first view can be a view of their own game. Contemporaneously with the actions of block 612, at block 614, process 600 can show a second window, different from the first window, that displays a split screen showing the game play of other users in the selected game application, such as all the other users, the highest scoring or ranked other users, other users that are on a team with the user whose play is shown in the first window, etc. Either or both the first window or the second window can include additional controls such as a friends or a consoles list configured to list other users or game devices associated with the customization system, a list of video streams of other games a user is watching, a list of other users identified as of interest or that a user recently viewed, details of one or more particular users, lists of in-progress games, controls for communications between users, tools to control switching video feeds between the first and second windows or organizing or sizing views within a window, etc. An example of a display implementing auto-launching an in-progress game with a multi-player split-screen display configuration is provided in FIG. 6C.

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the internet, a local area network, a wide area network, or a point-to-point dial-up connection. Thus, computer-readable media can comprise computer-readable storage media (e.g., “non-transitory” media) and computer-readable transmission media.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle specified number of items, or that an item under comparison has a value within a middle specified percentage range.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A method for redeployment of a GUI component to an alternate location, the method comprising:
receiving a selection of a GUI component;
receiving an identification of the alternate location; and
redeploying the GUI component to the alternate location by:
interfacing with a GUI application executing on a computing system to obtain a representation of the GUI component;
communicating with an output window that was not opened by the GUI application, wherein the output window is associated with the alternate location; and
using the obtained representation of the GUI component to present the GUI component in the output window at a position indicated by the alternate location.

2. The method of claim 1,
wherein the computing system is a first computing system; and
wherein the output window is on a second computing system different from the first computing system.

3. The method of claim 2,
wherein the identification of the alternate location includes a user selection of the second computing system.

4. The method of claim 2,
wherein communicating with the output window and using the obtained representation of the GUI component to present the GUI component in the output window is performed by sending a transmission with the obtained representation of the GUI component to the second computing system; and
wherein the second computing system is configured to, based on the transmission, interact with the output window to display the GUI component at the position indicated by the alternate location.

5. The method of claim 2,
wherein the GUI component is modified for display on the second computing system by one or more of:
transcoding the GUI component for use with a different codec;
adjusting a size of the GUI component;
adjusting a resolution of the GUI component;
adjusting a frame rate of the GUI component; or
any combination thereof.

6. The method of claim 1,
wherein the GUI application has opened one or more windows on a first display device of the computing system; and
wherein the output window is on a second display device, other than the first display device, of the computing system.

7. The method of claim 1 further comprising:
storing a mapping of the GUI component to the alternate location; and
automatically redeploying the GUI component to the alternate location, using the stored mapping, upon a subsequent execution of GUI application.

8. The method of claim 1,
wherein the GUI application is a game; and
wherein the selection of a GUI component is received using a software development kit provided by the game or using a plugin to the game.

9. The method of claim 1, wherein the selection of the GUI component is received though a user actuation on the GUI component in the GUI application.

10. The method of claim 1, wherein the identification of the alternate location is received through a drag-and-drop operation of the GUI component.

11. The method of claim 1 wherein presenting the GUI component in the output window at a position indicated by the alternate location further comprises modifying the GUI component by one or more of:
changing one or more colors of the GUI component;
changing one or more sizes of the GUI component;
changing one or more shapes of the GUI component;
changing one or more images of the GUI component;
reskinning the GUI component; or
any combination thereof.

12. The method of claim 1 further comprising:
receiving one or more user interactions or commands that were provided through interactions with the redeployed GUI component; and
providing the received one or more user interactions or commands to the GUI application.

13. The method of claim 12 wherein providing the received one or more user interactions or commands to the GUI application is performed using a software development kit provided by the GUI application or using a plugin to the GUI application.

14. The method of claim 12 wherein providing the received one or more user interactions or commands to the GUI application is performed by simulating user device input to the GUI application.

15. The method of claim 12 wherein the received one or more user interactions or commands is obtained by:
identifying coordinates of a user actuation relative to the redeployed GUI component; or
identifying a user action of a specific aspect of the redeployed GUI component.

16. A computer-readable storage medium storing instructions that, when executed by a computing system, cause the computing system to perform operations for redeployment of a GUI component to a redeployment location, the operations comprising:
receiving a selection of a GUI component;
receiving an identification of the redeployment location; and
redeploying the GUI component to the redeployment location by:
interfacing with a GUI application executing on the computing system to obtain a representation of the GUI component;
communicating with an output window that was not opened by the GUI application, wherein the output window is associated with the redeployment location; and
using the obtained representation of the GUI component to present the GUI component in the output window at a position indicated by the redeployment location.

17. The computer-readable storage medium of claim 16,
wherein the computing system is a first computing system;
wherein the output window is on a second computing system different from the first computing system;
wherein the identification of the redeployment location is received with a user selection of the second computing system;
wherein communicating with the output window and using the obtained representation of the GUI component to present the GUI component in the output window is performed by sending a transmission with the obtained representation of the GUI component to the second computing system; and
wherein the second computing system is configured to, based on the transmission, interact with the output window to display the GUI component at the position indicated by the redeployment location.

18. The computer-readable storage medium of claim 16, wherein the operations further comprise:
storing a mapping of the GUI component to the redeployment location; and
automatically redeploying the GUI component to the redeployment location, using the stored mapping, upon a subsequent execution of GUI application.

19. A system comprising:
a memory;
one or more processors;
an interface configured to receive a GUI component and a mapping of the GUI component to a redeployment location on specified device, wherein the GUI component is received from a computing system other than the specified device; and
a content formatter configured to format the GUI component for display on the specified device;
wherein the interface is further configured to send a transmission, including the formatted GUI component, to the specified device;
wherein transmission causes the specified device to:
interact with an output window associated with the redeployment location to present the GUI component in the output window at a position indicated by the redeployment location.

20. The system of claim 19, wherein the interface is further configured to:
receive one or more user interactions or commands that were provided through input to the GUI component on the specified device; and
provide the received one or more user interactions or commands to the computing system, wherein the computing system is configured to provide the one or more user interactions or commands to a GUI application, executing on the computing system, that is associated with the GUI component.
